(19) United States
(12) Patent Application Publication
(10) Pub. No.: US 2013/0059468 A1
(43) Pub. Date: Mar. 7, 2013

(54) Coaxial Connectors Having Rearwardly-Seating Compression Elements and Related Jumper Cables and Methods of Using Such Connectors

(71) Applicant: Kenneth Steven Wood, Elmira, NY (US)

(72) Inventor: Kenneth Steven Wood, Elmira, NY (US)

(73) Assignee: CommScope, Inc. of North Carolina

(21) Appl. No.: 13/591,295

(22) Filed: Aug. 22, 2012

Related U.S. Application Data
(60) Provisional application No. 61/530,530, filed on Sep. 2, 2011.

(51) Int. Cl. H01R 9/05; H01R 43/16

(52) U.S. Cl. 439/584; 439/578; 29/874

(57) ABSTRACT

Coaxial connectors include have a rear cable-receiving end and a front connection end that is opposite the cable-receiving end. These connectors include a connector body having a front end that extends toward the front connection end of the coaxial connector and a rear end opposite the front end and a compression element that is configured to move between an unseated position and a seated position, the compression element configured to impart a compressive force to secure one or more elements of a cable within the connector body when the compression element is in the seated position. The compression element is designed to be closer to the front connection end of the coaxial connector when in the unseated position than it is when in the seated position.

### CROSS-REFERENCE TO RELATED APPLICATION

The present application claims priority under 35 U.S.C. §119(e) from U.S. Provisional Patent Application Ser. No. 61/530,530, filed Sep. 2, 2011, entitled COAXIAL CONNECTORS HAVING REARWARDLY-SEATING COMPRESSION ELEMENTS AND RELATED JUMPER CABLES AND METHODS OF USING SUCH CONNECTORS, the entire contents of which is incorporated herein by reference in its entirety.

### FIELD OF THE INVENTION

The present invention relates generally to communications connectors and, more particularly, to connectors for coaxial cables.

### BACKGROUND

Coaxial cables are a well-known type of electrical cable that may be used to carry information signals such as television or data signals. Coaxial cables are widely used in cable television networks and to provide broadband Internet connectivity, FIGS. 1A and 1B are, respectively, a transverse cross-sectional view and a longitudinal cross-sectional view of a conventional coaxial cable 10 (FIG. 1B is taken along the cross section 1B-1B shown in FIG. 1A). As shown in FIGS. 1A and 1B, the coaxial cable 10 has a central conductor 12 that is surrounded by a dielectric 14. A tape 16 is preferentially bonded to the dielectric 14. The central conductor 12, dielectric 14 and tape 16 comprise the core 18 of the cable. Electrical shielding wires 20 and, optionally, electrical shielding tape(s) 22 surround the cable core 18. Finally, a cable jacket 24 surrounds the electrical shielding wires 20 and electrical shielding tape(s) 22. As shown in FIG. 1B, the dielectric 14, tape 16, electrical shielding wires 20, electrical shielding tape 22 and cable jacket 24 may be cut, and the electrical shielding wires 20, electrical shielding tape 22 and cable jacket 24 may be folded back, in order to prepare the coaxial cable 10 for termination into certain types of coaxial connectors.

Coaxial connectors are a known type of connector that may be used to connect two coaxial cables 10 or to connect a coaxial cable 10 to a female connector port on a device (e.g., a television, a cable modem, etc.) having a coaxial cable interface. A wide variety of coaxial connectors are known in the art including, for example, coaxial “F” connectors, bayonet-navy or “BNC” connectors, MCX connectors, MMCX connectors, RCA connectors, APC-7 connectors and the like. With many if not most coaxial connectors, the connector is terminated onto a coaxial cable by inserting the coaxial cable into the connector and then forcibly moving a compression element of the connector from an unseated position to a seated position in order to lock the coaxial cable in place inside the connector.

Perhaps the most ubiquitous coaxial connector is the F-style coaxial connector that is typically used to connect televisions, VCRs, cable modems, set top boxes and other cable television and broadband Internet devices to cable television networks. F-style coaxial connectors are male coaxial connectors that may be mated with a corresponding female connector port by threading an internally-threaded rotatable nut of the F-style coaxial connector onto the external threads of the female connector port. A number of different types of F-style coaxial connector designs are known in the art, including, but not limited to, crimped connectors, swaged connectors and connectors which secure the cable into the connector with compression-style cable retention elements. With the crimped connector designs, typically a hexagonal-shaped tool is used to crimp a sleeve of the connector onto the coaxial cable that is to be terminated into the connector. With the swaged connector designs, the sleeve of the connector is swaged circumferentially inward so as to reduce its inside diameter in order to exert the required retention force on the coaxial cable. The compression-style connector designs typically force a compression sleeve into or over a body of the coaxial connector in order to lock a coaxial cable in place therein.

### SUMMARY

Pursuant to embodiments of the present invention, coaxial connectors are provided that have a rear cable-receiving end and a front connection end that is opposite the cable-receiving end. These coaxial connectors include a connector body that has a front end that extends toward the front connection end of the coaxial connector and a rear end that is opposite the front end. These coaxial connectors further include a compression element that is configured to move between an unseated position and a seated position, where the compression element is configured to impart a compressive force to secure one or more elements of a cable within the connector body when the compression element is in the seated position. The compression element is closer to the front connection end of the coaxial connector when in the unseated position than when in the seated position

In some embodiments, the coaxial connector comprises an F-style coaxial connector that further includes a rotatable nut that is mounted on the front end of the connector body and an inner contact post that is at least partly within the connector body. The compression element may be permanently attached to the connector body. In some embodiments, the compression element may be positioned between the connector body and the inner contact post, while in other embodiments, the compression element may be positioned over an outer surface of the connector body.

In some embodiments, the rear end of the connector body may include an opening, and the contact post may extend rearwardly through the opening beyond the rear end of the connector body. In some embodiments, the contact post extends rearwardly beyond a rear end of the compression element when the compression element is in the unseated position. In some embodiments, the entirety of the compression element may be between the front end and the rear end of the connector body when the compression element is in the unseated position.

In some embodiments, the connector body is a two-piece unit that includes a front metal body element and a rear resilient body element. In these embodiments, the rear resilient body element may be is partially positioned inside the front metal body element. The rear resilient body element may include a generally cylindrical element that has an open interior, where a rear end of the cylindrical element flares outwardly. The rear end of this cylindrical element may also include a plurality of slots.

In some embodiments, an outer surface of the compression element may include a circular groove therein that is configured to receive a gripping element of a compression tool that is used to move the compression element from the unseated position to the seated position. The compression element may be formed of a metal. The connector body may include a stop that is configured to prevent the compression element from moving rearwardly beyond the seated position. Moreover, in some embodiments, the contact post may extend farther rearwardly than the connector body. In all of the above-described embodiments, the coaxial connector may be mounted onto a coaxial cable to provide a coaxial jumper cable.

Pursuant to further embodiments of the present invention, coaxial connectors are provided that have a front connection end and a rear cable-receiving end that is opposite the front connection end. These coaxial connectors include a connector body having a front end that extends toward a front connection end of the coaxial connector and a rear end opposite the front end, a rotatable nut that is mounted on the front end of the connector body and an inner contact post that is positioned within a rear portion of the rotatable nut and within the connector body. These coaxial connectors further include a compression element that is permanently attached to the connector body that is configured to move rearwardly from an unseated position to a seated position.

In some embodiments, a rear end of the compression element is closer to the front connection end of the coaxial connector than is a rear end of the contact post when the compression element is in the unseated position. In some embodiments, a rear end of the compression element is closer to the front connection end of the coaxial connector than is a rear end of the connector body when the compression element is in the unseated position. These connectors may be designed so that the compression element does not obscure the view into the rear end of the coaxial connector when the compression element is in the unseated position.

Pursuant to further embodiments of the present invention, methods of terminating a coaxial connector onto an end of a coaxial cable are provided in which the end of the coaxial cable is inserted into a rear cable-receiving end of the coaxial connector. Then, a compression element of the coaxial connector is moved along a longitudinal axis of the coaxial connector in a direction from a front connection end of the coaxial connector toward the rear cable-receiving end of the coaxial connector in order to impart a compressive force on at least a portion of the coaxial cable that locks the coaxial cable within the coaxial connector.

In some embodiments, the method may further include preparing the end of the coaxial cable prior to inserting the end of the coaxial cable into the rear cable-receiving end of the coaxial connector. In some embodiments, the connector body may be a two-piece connector body that includes a first metal body element that forms the front end of the connector body and a second resilient body element that forms the rear end of the connector body, and the compression element may impart an inward force on the second resilient body element that forces the second resilient body element to move inwardly towards the longitudinal axis of the coaxial connector when the compression element is moved rearwardly from an unseated position to a seated position

### BRIEF DESCRIPTION OF THE DRAWINGS

FIGS. 1A and 1B are, respectively, a transverse cross-sectional diagram and a longitudinal cross-sectional diagram of a conventional coaxial cable.

FIG. 2A is a perspective view of a coaxial connector according to certain embodiments of the present invention.

FIG. 2B is an end view of the coaxial connector of FIG. 2A,

FIG. 2C is a cross-sectional view of the coaxial connector of FIGS. 2A-B taken along the line 2-2 of FIG. 2B where the compression sleeve of the coaxial connector is in its unseated position.

FIG. 2D is a cross-sectional view of the coaxial connector of FIGS. 2A-B taken along the line 2-2 of FIG. 2B where the compression sleeve of the coaxial connector is in its seated position.

FIG. 3A is a perspective view of a coaxial connector according to further embodiments of the present invention.

FIG. 3B is an end view of the coaxial connector of FIG. 3A.

FIG. 3C is a cross-sectional view of the coaxial connector of FIGS. 3A-B taken along the line 3-3 of FIG. 3B where the compression sleeve of the coaxial connector is in its unseated position.

FIG. 3D is a cross-sectional view of the coaxial connector of FIGS. 3A-B taken along the line 3-3 of FIG. 3B where the compression sleeve of the coaxial connector is in its seated position.

### DETAILED DESCRIPTION

Embodiments of the present invention are directed to coaxial connectors, with a primary example of such being F-style coaxial connectors. As used herein, the term “longitudinal” and derivatives thereof refer to the direction defined by the central axis of the coaxial connector, which is generally coexistent with the central axis of the end portion of a coaxial cable on which the coaxial connector is installed. The terms “front”, “front end”, “forward” and similar terms, when used with respect to a coaxial connector or component pieces thereof, refer to the end of the coaxial connector that mates with another coaxial connector such as, for example, a coaxial connector port on a television set, cable modem or the like. Thus, the “front” or “front end” or “forward” portion of an F-style coaxial connector refers to the end of the connector that includes a nut that is configured to be threaded onto a mating female coaxial connector port. Likewise, references herein to the “rear” or “rear end” of a coaxial connector refer to the end of the coaxial connector that is opposite the front end (i.e., the rear end is the end of the connector that receives a coaxial cable).

F-style coaxial connectors that include compression sleeves have been available for many years in many different package forms. Early compression-activated F-style coaxial connectors were delivered as two-piece connectors. The first piece included the connector body, inner contact post and nut. The compression sleeve was provided as a separate second piece. However, these two-piece F-style coaxial connectors had a distinct disadvantage in that the separate compression sleeve was often dropped by installers and sometimes lost before or during the installation process. Other early F-style coaxial connectors such as, for example, the connectors shown in U.S. Pat. No. 4,834,675 to Samchisen (“the '675 patent”), delivered the connectors as a single piece connector, with the compression sleeve attached by a thin web of plastic to a plastic ring that encircled the connector body. An installer removed the compression sleeve by manipulating it a few times to break the thin plastic web, and the compression sleeve could then be placed over the end of a coaxial cable on which the connector was to be installed. While the connectors of the '675 patent were delivered as one-piece connectors, in practice, the compression sleeve often became detached from the connector body prior to installation and, in any event, the compression sleeves were still susceptible to being dropped and/or lost during the installation process.

Thereafter, F-style coaxial connectors were developed in which the compression sleeve was integrated into the rear end of the connector body at the factory, and delivered as a one-piece connector. An example of such a connector is disclosed in U.S. Pat. No. 5,470,257 to Szegda (“the '257 patent”). As discussed in the '257 patent, pre-installing the compression sleeve in the rear end of the connector overcame the above-mentioned problems of lost or misplaced compression sleeves that occurred with earlier coaxial connectors. In the design of the '257 patent, the compression sleeve is moved from an unseated position within the connector body which allows for installation of a coaxial cable into the connector body to a seated position in which the compression sleeve locks the coaxial cable into place within the connector body. In these coaxial connector designs, the connector is shipped from the factory with the compression sleeve in its unseated position, and an installer in the field then uses a compression tool to move the compression sleeve into its seated position after the coaxial cable has been inserted into the connector body to lock the coaxial cable in place. With these connector designs, the installer must insert the coaxial cable through the compression sleeve during the installation process.

More recently, coaxial connectors have been provided that include a compression sleeve that is integrated into the rear end of the connector body at the factory and delivered as a one-piece connector, but the compression sleeve is designed so that it can be subsequently detached by an installer. An example of such a connector is disclosed in U.S. Pat. No. 6,530,807 to Rodrigues (“the '807 patent”). After detaching the compression sleeve from the connector body, the installer may place the compression sleeve over the coaxial cable and move it away from the end of the cable (so that it is out of the way), and then insert the end of the coaxial cable into the connector body. As the compression sleeve is spaced apart from the connector during the cable insertion process, the installer may more easily insert the cable into the connector at the proper angle and make sure that the cable is properly seated over the inner contact post. The compression sleeve can then be slid along the coaxial cable until it contacts the connector body, at which point the installer may reattach the compression sleeve to the connector body and then use a compression tool to seat the compression sleeve and thereby lock the coaxial cable into place within the connector body.

Each of the above coaxial connectors may have various disadvantages. The older two piece coaxial connectors and the coaxial connectors according to the '675 patent often resulted in dropped, hard-to-find and/or lost compression sleeves. The connectors having the compression sleeve pre-installed into the rear end of the connector body such as the coaxial connectors of the '257 patent overcome the potential problems of lost or hard-to-find compression sleeves, but force installers to insert the coaxial cable into the connector body while the compression sleeve is in place. As a result, with these one-piece connectors it is often more difficult for the installer to make sure that the cable is being inserted at the correct angle and/or that the cable has been firmly seated over the inner contact post due to the “blind entry” that necessarily results if the cable is inserted into the connector body while the compression sleeve is in place. If the dielectric tape 16 of the coaxial cable 10 is inserted at an angle relative to the inner contact post, it can catch on the inner contact post and be torn. The cable is more likely to be inserted at such an angle during blind entry installations. Additionally, when the coaxial cable is blindly inserted within the connector (as the compression sleeve blocks the installer's view into the connector), the folded braiding 20 and/or tape 22 of the coaxial cable 10 may not be properly seated inside the connector, which can lead to water migration or other problems. Moreover, when the compression sleeve is in place during cable installation, a higher force must be applied when inserting the coaxial cable into the connector body, and the application of this increased force may increase the possibility that either the cable or the connector is damaged during the cable insertion process.

The coaxial connectors having a pre-installed compression sleeve that may be snapped out by the installer, such as the coaxial connectors of the '807 patent, may alleviate the issues associated with both lost connector pieces and blind entry insertion. However, in practice, installers may be unaware that the compression sleeve is detachable and/or may not take the additional time to detach the compression sleeve from the connector body, and hence the installers may not take advantage of the fact that the compression sleeve is detachable. Consequently, damaged cables and connectors and/or poor connections may also be obtained when these coaxial connectors are used. Additionally, once detached, the compression sleeves of the coaxial connectors of the '807 patent can be dropped and/or potentially lost by an installer.

Pursuant to embodiments of the present invention, compression-style coaxial connectors are provided that have compression elements that slide rearwardly when moving from an unseated position to a seated position in order to lock a coaxial cable within the connector. This is in direct contrast to conventional compression-style coaxial connector designs, which have a compression element that is inserted into (or over) a rear end of the connector and then forcibly driven forwardly in order to lock a coaxial cable within the connector. Thus, the coaxial connectors according to embodiments of the present invention have “rearwardly-seating” compression elements since the compression sleeve is moved rearwardly as opposed to forwardly to lock a coaxial cable within the connector.

The coaxial connectors according to embodiments of the present invention may exhibit a number of performance advantages over conventional coaxial connectors. For example, since the compression sleeve of the coaxial connectors according to embodiments of the present invention is moved rearwardly to lock a coaxial cable in place, the compression sleeve may be located forwardly from the rear end of the connector when it is in its unseated position. As such, the compression sleeve may be designed so that it does not partially obstruct an installer's view into the rear end of the connector during the cable installation process. As a result, the coaxial connectors according to embodiments of the present invention may avoid the “blind entry” problem that exists with many conventional coaxial connectors, which can result in an increased incidence of damaged coaxial cables and/or mis-installations. Additionally, the coaxial connectors according to embodiments of the present invention may have a one-piece design with a compression sleeve that is permanently attached to the connector body, and hence the compression sleeve cannot be dropped or lost before or during the installation process.

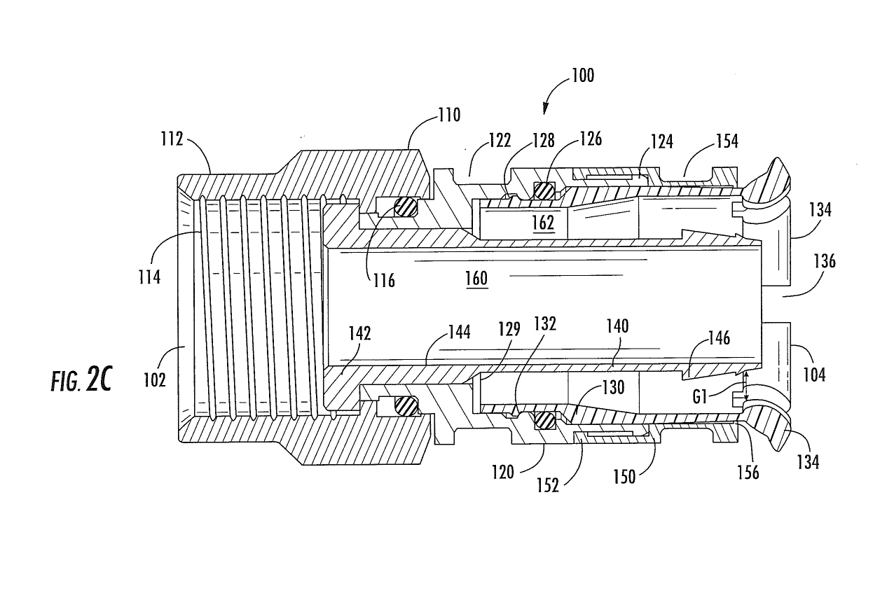

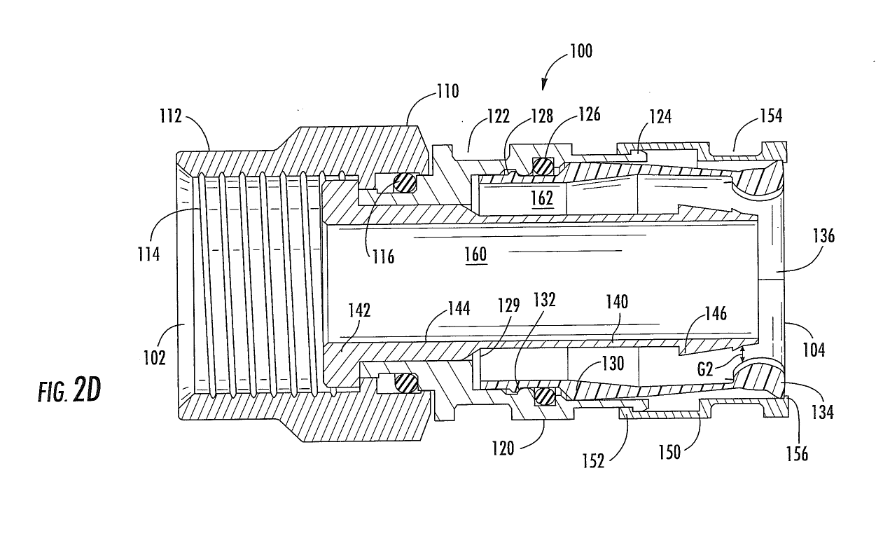

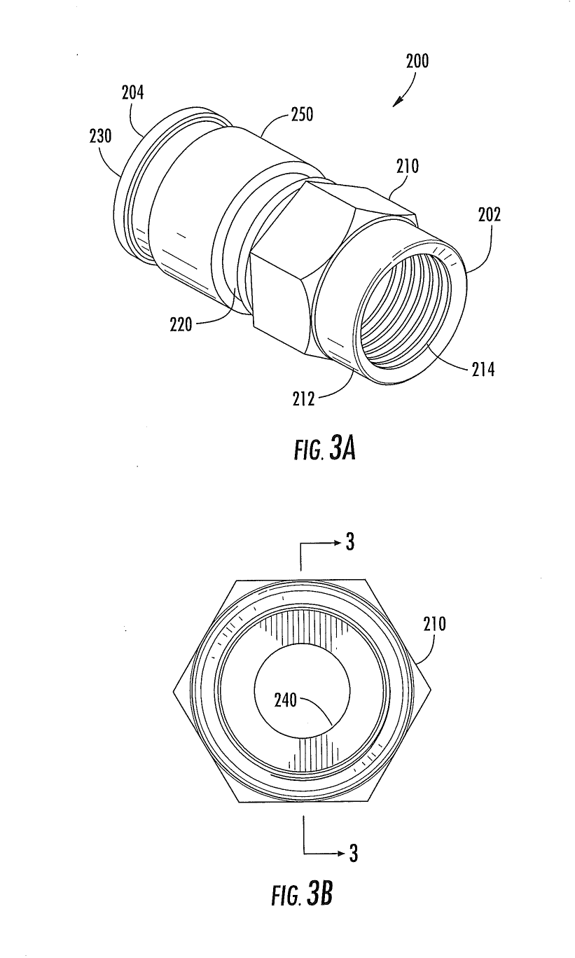

FIGS. 2A-2D illustrate an F-style coaxial connector 100 according to certain embodiments of the present invention. In particular, FIG. 2A is a perspective view of the coaxial connector 100 and FIG. 2B is an end view thereof. FIGS. 2C and 2D are cross-sectional views of the connector 100 taken along the line 2-2 of FIG. 2B. In FIG. 2C, the compression sleeve of coaxial connector 100 in its unseated position, while in FIG. 2D the compression sleeve of coaxial connector 100 is in its seated position.

As shown in FIGS. 2A-2D, the connector 100 has a front end 102 and a rear end 104. An internally threaded nut 110 is positioned at the front end 102 of the connector 10. The connector 100 further includes a generally tubular front connector body 120 and a generally tubular rear connector body 130. The connector 100 further includes an inner contact post 140 that is received within an interior of the internally threaded nut 110 and both of the front and rear connector bodies 120, 130. A forward base portion 142 of the contact post 140 is forcibly inserted within a forward portion of the front connector body 120 in order to lock the front connector body 120, the contact post 140 and the internally threaded nut 110 together to form an integral unit. The rear connector body 130 is similarly forcibly inserted within the front connector body 120 in order to lock the rear connector body 130 in place. Finally, an external compression sleeve 150 is provided over exterior portions of the front connector body 120 and the rear connector body 130. A coaxial cable 10 (not shown) may be terminated into the rear end 104 of the connector 100. The internally-threaded nut 110 at the front end 102 of the connector 100 may be mounted onto a female connector port (not shown).

The internally threaded nut 110 may comprise, for example, a brass or steel nut having an exterior surface that has a hexagonal transverse cross-section. The nut 110 may include a forward lip 112 that has an exterior surface that has a non-hexagonal cross-section such as, for example, a circular transverse cross-section. The internally threaded nut 110 is mounted over the front end of the front connector body 120. The interior surface of the front end of the nut 110 includes a plurality of threads 114. An O-ring, gasket or other member 116 (see FIGS. 2C and 2D) may be positioned between the internally threaded nut 110 and the front connector body 120 to reduce or prevent water or moisture ingress into the interior of the connector 100. The nut 110 may rotate freely around the contact post 140 and the front connector body 120.

The front connector body 120 may comprise a generally cylindrical body piece having an open interior. As shown best in FIGS. 2C and 2D, the outer and/or inner diameter of the front connector body 120 may vary along the length of the front connector body 120. The front connector body 120 may be formed, for example, of brass or steel or another metal or metal alloy. The front connector body 120 includes a circular external groove 122 that may be configured to receive a first gripping element of a compression tool. The rear end of the front connector body 120 includes an annular stop 124. An annular groove is provided in an internal surface of the front connector body 120 that receives an O-ring 126.

The rear connector body 130 may also comprise a generally cylindrical body piece having an open interior. As shown best in FIGS. 2C and 2D, a forward portion of the rear connector body 130 is positioned inside the front connector body 120. An annular ridge 132 is provided on the outside surface of the rear connector body 130 that fits within a mating groove 128 on the inside surface of the front connector body 120 in order to lock the rear connector body 130 within the front connector body 120. The rear end of the rear connector body 130 includes a plurality of teeth 134 that flare outwardly so as to define a circle having an increased outer diameter as compared to the remainder of the rear connector body 130. The teeth 134 are separated by longitudinal channels 136. The rear connector body 120 may be formed of a resilient material such as, for example, a plastic material.

The inner contact post 140 is mounted within both the front connector body 120, the rear connector body 130 and the internally threaded nut 110. The inner contact post 140 has a generally annular shape and includes a base portion 142 that is positioned inside the internally-threaded nut 110 and a distal end that is adjacent the read end 104 of the connector 100. The inner contact post 140 is used to connect the internally threaded nut 110 to the front connector body 120, and may facilitate mounting the nut 110 to the front connector body 120 so that the nut 110 may be freely rotated independent of the front connector body 120. The outside surface of the inner contact post 140 may include one or more serrations, teeth, lips or other structures 146 that are provided at or near the distal end thereof. The inner contact post 140 may comprise, for example, a brass or steel post.

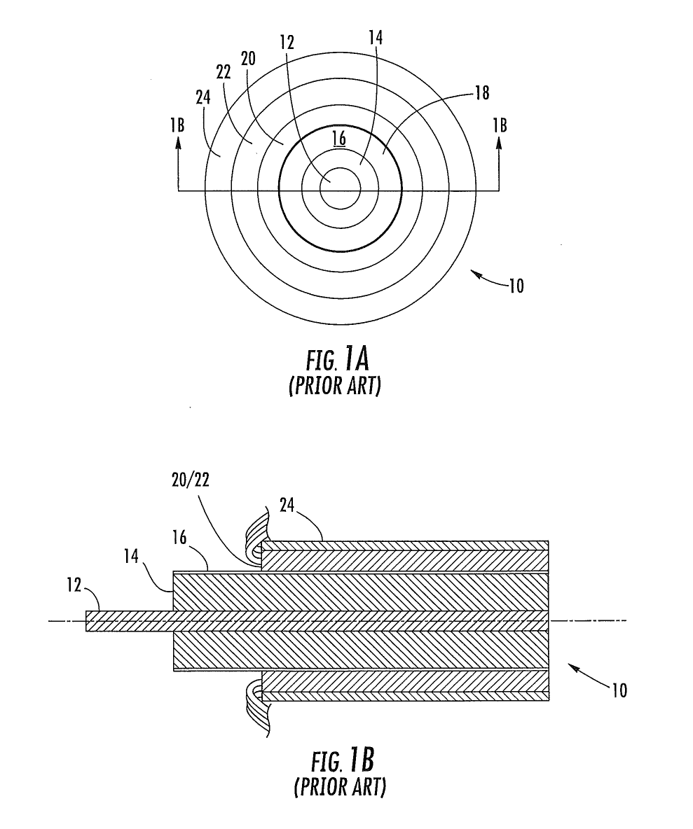

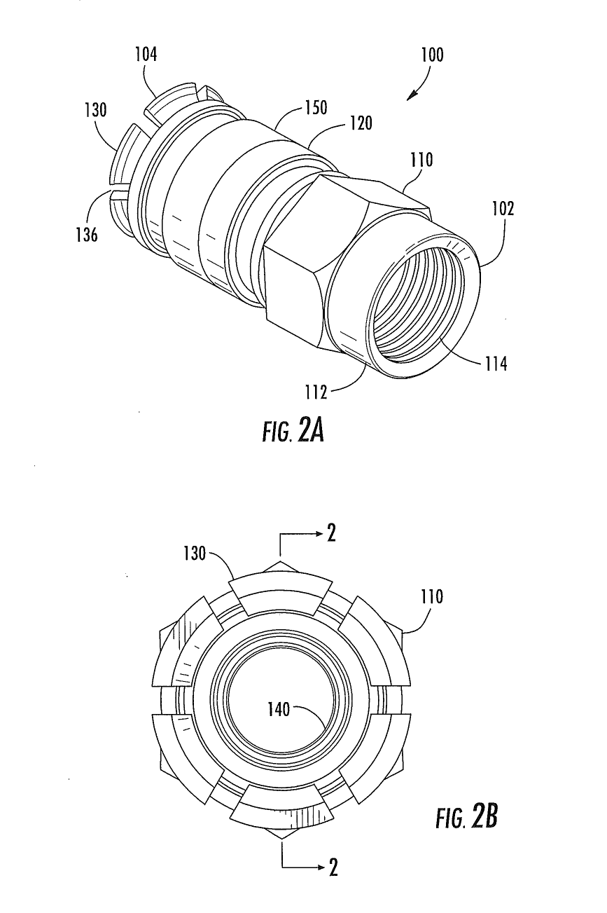

The interior of the inner contact post 140 defines a cylindrical, open-ended chamber 160 that receives the core 18 of an end portion of a coaxial cable such as coaxial cable 10 of FIGS. 1A-1B when the connector 100 is installed onto the coaxial cable 10 to provide a coaxial jumper cable (i.e., a coaxial cable having a connector on at least one end thereof). The rear connector body 130 and the inner contact post 140 define an annular chamber 162 that receives the electrical shielding wires 20, any tape 22 and the cable jacket 24 of the coaxial cable 10.

The compression sleeve 150 may comprise an annular tube that is positioned over portions of the outside surfaces of the front connector port 120 and the rear connector port 130. The compression sleeve 150 may be formed of a fairly rigid material (e.g., more rigid than the material used to form the rear connector body 130) such as steel, brass or another metal or metal alloy. The forward portion of the compression sleeve 150 may include a first stop 152 that prevents the compression sleeve 150 from travelling rearwardly any farther than the stop 124 on the rear end of the front connector body 120. The outside surface of the rear portion of the compression sleeve 150 includes a circular groove 154 in that may be configured to receive a second gripping element of a compression tool. FIG. 2C illustrates the compression sleeve in its unseated position, which is the position that the compression sleeve 150 may be in when shipped from the factory and/or prior to the insertion of a coaxial cable therein. FIG. 2D illustrates the compression sleeve in its seated position, which is the position that the compression sleeve 150 is moved to when the coaxial connector is mounted on the end of a coaxial cable to form a coaxial jumper cable. An annular ridge 156 is provided on the interior surface of the rear portion of the compression sleeve 150 that acts as a stop to lock the compression sleeve 150 in place when the compression sleeve 150 is in its seated position, as will be discussed in further detail below.

A coaxial cable such as coaxial cable 10 of FIGS. 1A-1B may be terminated into the F-style coaxial connector 100 of FIGS. 2A-2D as follows. First, the end portion of the coaxial cable 10 is prepared in the manner discussed above with respect to FIG. 1B so that the end of the cable 10 has three specially prepared segments, namely a first (end) segment that includes only the center conductor 12, followed by a second segment that includes the inner conductor 12, the dielectric 14 and the tape 16, followed by a third segment that comprises the full cable with the electrical shielding wires 20 and electrical shielding tape 22 from the second segment folded back over the cable jacket 24. There are commercially available preparation tools that will produce all of the appropriately dimensioned segments in one cutting operation. One such tool is an SDT series tool available from Ripley Tools.

Next, with the compression sleeve 150 in its unseated position (i.e., in the position illustrated in FIG. 2C), the prepared end of the coaxial cable 10 is inserted into the rear of the connector 100. The inner core 18 of the coaxial cable 10 (i.e., inner conductor 12, dielectric 14 and tape 16) may be axially inserted into the cylindrical chamber 160 defined by the inside diameter of the contact post 140, while the electrical shielding wires 20 and tape 22 and the cable jacket 24 are inserted within the annular chamber 162 defined by the exterior of the contact post 140 and the inside diameter of the rear connector body 130 so as to circumferentially surround the outer surface of inner contact post 140. The prepared end of the coaxial cable 10 is inserted as far as it will go into the connector 100 so that the central conductor 12 thereof extends all the way through the inner contact post 140 into the threaded portion 114 of the internally-threaded nut 110. When the coaxial cable 10 is fully inserted within the connector 100, the folded back electrical shielding wires 20 and any tape 22 will extend as far forwardly as they possibly can so as to make physical and electrical contact with a sidewall 129 of the front connector body 120 that is adjacent a thickened portion 144 of the contact post 140. The length of the annular chamber 162 that receives the electrical shielding wires 20 and any tape 22 may be greater than the length of the folded back portion of the electrical shielding wires 20 and any tape 22 (e.g., the annular chamber 162 may be about twice as long) so that an unprepared segment of the coaxial cable 10 enters into a portion of the annular chamber 162.

Next, the installer may take a compression tool (not shown) and place a first gripping element thereof in the circular groove 122 in the exterior surface of the front connector body 120 and place a second gripping element of the compression tool in the circular groove 154 in the exterior surface of the compression sleeve 150. The installer then activates the compression tool (e.g., by squeezing together the handles of a pliers-like compression tool), which forces the compression sleeve 150 and the front connector body 120 to move away from each other in the longitudinal direction (i.e., the compression sleeve 150 moves axially towards the rear of coaxial connector 100). As the compression sleeve 150 moves rearwardly, the rear edge thereof will contact the teeth 134 that flare outwardly at the rear end of the rear connector body 130 since the external diameter of the portion of the rear connector body 130 that includes the teeth 134 exceeds the internal diameter of the rear end of the compression sleeve 150. Since the rear connector body 130 is more resilient than the compression sleeve 150 (e.g., the rear connector body 130 may comprise a plastic material while the compression sleeve 150 may comprise a metal or metal alloy), the forced rearward movement of the compression sleeve 150 by the compression tool causes the teeth 134 at the rear end of the rear connector body 130 to bend inwardly toward the longitudinal axis of the connector 100. The longitudinal grooves 136 facilitate allowing the teeth 134 to bend inwardly in this fashion, as this inward motion forces the teeth 134 closer together.

Eventually, the stop 152 on the front end of the compression sleeve 150 will engage the stop 124 on the rear end of the front connector body 120, which will halt the rearward movement of the compression sleeve 150. At this point, the compression sleeve 150 is in its seated position of FIG. 2D. As shown in FIG. 2D, in this seated position, the annular ridge 156 on the rear end of the compression sleeve 150 will have moved past the sidewalls of the teeth 134 to engage the respective back edges of the teeth 134. The engaged facing surfaces of the annular ridge 156 and the back edges of the teeth 134 act to prevent the compression sleeve 150 from returning to its unseated position (i.e., once the compression sleeve is moved into the seated position of FIG. 2D, it cannot be readily moved back into the unseated position of FIG. 2C).

As can be seen by comparing FIGS. 2C and 2D, when the compression sleeve 150 is forced into its seated position, a radial gap between the tooth 146 on the inner contact post 140 and the interior surface of the rear connector body 130 is reduced from a gap of G1 in FIG. 2C to a gap of G2 in FIG. 2D. The gap G2 may be designed to be less than the thickness of the electrical shielding wires 20, tape 22 and cable jacket 24 of coaxial cable 10. Consequently, as the radial gap is reduced from G1 to the gap G2 as the compression sleeve 150 is moved to its seated position, the rear connector body 130, which is being forced inwardly, may impart a generally 360-degree circumferential compressive force on the electrical shielding wires 20, tape 22 and cable jacket 24, thereby pressing the shielding wires/tape 20, 22 and the cable jacket 24 against the outer surface of inner contact post 140. Once the compression sleeve 150 has been moved all the way into its fully seated position, this compressive force, in conjunction with the serrations, teeth or the like 146 on the outside surface of the inner contact post 140, act to lock the coaxial cable 10 within the coaxial connector 100 with a gripping/retention force that is applied to the coaxial cable 10 that meets SCTE requirements for connector pull-off as well as additional electrical, mechanical and environmental requirements. This gripping/retention force may also contribute toward a positive moisture seal at the cable-connector interface.

The coaxial connector 100, and the various other coaxial connectors according to embodiments of the present invention, may offer several advantages over conventional coaxial cables.

First, as is apparent from the cross-sectional diagram of FIG. 2C, when the compression sleeve 150 is in its unseated position, it does not obstruct the installer's view into the interior of the connector 100, as the rear edge of the compression sleeve 150 is positioned forward of the openings in the rear of the connector 100 that receive the coaxial cable 10. As such, the coaxial connectors according to embodiments of the present invention can avoid the “blind entry” problem that arises with many prior art coaxial connectors where an installer is forced to—or chooses to as a matter of expediency—insert the coaxial cable into the coaxial connector through a compression sleeve that is already mounted in an unseated position in the interior of the rear end of the connector. When such blind entry installations are performed, the probability that the coaxial cable or connector will be damaged or installed improperly may increase significantly. A significant percentage of F-style coaxial connector installations (e.g., as many as 10% or more) may be performed improperly, particularly when the connectors are used to terminate heavily shielded cables such as quad cables. Such improper installations can result in additional service trips by, for example, a cable television provider to subscriber premises, which can dramatically increase a cable television company's operating expenses. Thus, by ensuring that the compression sleeve 150 will not obstruct an installer's view so that the installer can correctly align the cable 10 with the inner contact post 140 and the rear connector body 130 during above-described cable termination process, the coaxial connectors according to embodiments of the present invention may facilitate reducing overall costs for cable television companies and other service providers who install coaxial connectors.

Second, since the compression sleeve 150 is not within the rear opening of the coaxial connector 100 nor does it act to reduce the size of the rear opening at the point where the coaxial cable 10 is inserted into the connector 100, the installer may need to impart less force on the coaxial cable 10 in order to position the cable 10 in the proper position within the connector 100. As the tape 22 and electrical shielding wires 20 of coaxial cable 10 are susceptible to damage, installations that use less force will generally reduce the probability that the coaxial cable is damaged during the installation process. If the coaxial cable is damaged during installation, the installer may need to trim the cable and install a second coaxial cable thereon. Moreover, in some cases, the installer may not realize that the coaxial cable was damaged, and hence the damage to the cable may require a follow-up service call at a later date to replace the damaged cable segment.

Third, the coaxial connector 100 is a one-piece connector that does not include a removable compression sleeve. As discussed above, in order to address the blind entry problem, various prior art connectors include a detachable/re-attachable compression sleeve that is shipped as a one-piece unit from the factory. An installer may then detach the compression sleeve, if desired, at the time of installation and place it further down the coaxial cable in order to have a clear view into the interior of the connector during the installation process. While these prior art coaxial connectors provide a solution to the blind entry problem, they at the same time create another problem—namely the problem of dropped, lost or misplaced compression sleeves—that can arise any time a detachable compression sleeve is used. In addition, installers of the prior art one-piece coaxial connectors having detachable/re-attachable compression sleeves also often have incentives to complete installations as quickly as possible, and thus may perform blind entry installations as a matter of expediency, since the later malfunctioning of the coaxial connector may well be someone else's problem. The one piece coaxial connectors according to embodiments of the present invention may avoid each of these potential problems.

Fourth, the coaxial connector 100 has a generally tubular shape, in contrast to the prior art connectors shown, for example, in the above-described '257 patent, which have side-mounted compression sleeves. These prior art connectors, when stored loosely in a pouch, bag or box as is typically the case, are prone to become hooked or tangled with other connectors, which can make it more difficult for an installer to quickly pull a single connector out of the storage pouch. Additionally, the force exerted by an installer to segregate tangled connectors can, in practice, be sufficient to rip the compression sleeve off of the prior art connectors of the '257 patent, leading to lost compression sleeves. In contrast, the generally tubular connectors according to embodiments of the present invention should not easily become tangled with each other, making it easier for an installer to quickly and easily pull a single connector out of a storage bag, pouch or box.

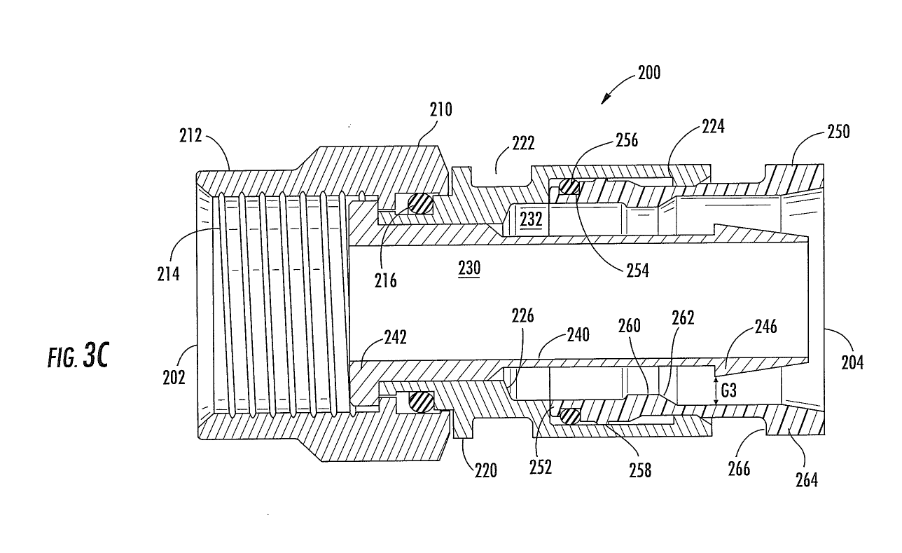

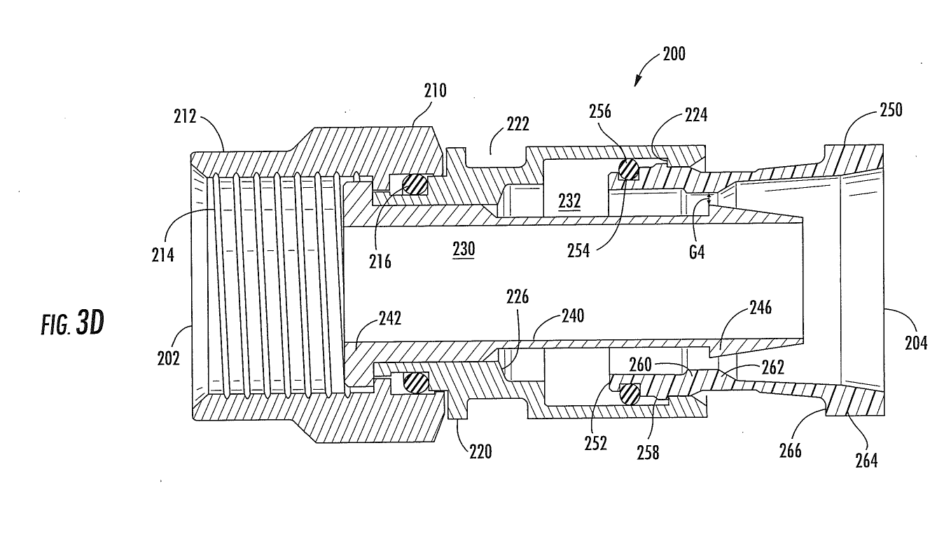

FIGS. 3A-3D illustrate a coaxial connector 200 according to further embodiments of the present invention. In particular, FIG. 3A is a perspective view of the coaxial connector 200, FIG. 3B is an end view of the coaxial connector 200, and FIGS. 3C and 3D cross-sectional views of the coaxial connector 200 taken along the line 3-3 of FIG. 3B where the compression sleeve 250 of the coaxial connector 200 is in its unseated and seated positions, respectively.

As shown in FIGS. 3A-3D, the connector 200 has a front end 202 and a rear end 204. An internally threaded nut 210 is positioned at the front end 202 of the connector 200. The connector 200 further includes a generally tubular connector body 220, as well as an inner contact post 240 that is received within an interior of the internally threaded nut 210 and the connector body 220. A forward base portion 242 of the contact post 240 is forcibly inserted within a forward portion of the connector body 220 in order to lock the connector body 220, the contact post 240 and the internally-threaded nut 210 together to form an integral unit. An internal compression sleeve 250 is permanently mounted within the connector body 220. A coaxial cable (not shown) may be terminated into the rear end 204 of the connector 200. The internally-threaded nut 210 at the front end 202 of the connector 200 may be mounted onto a female connector port (not shown).

The internally threaded nut 210 may comprise, for example, any conventional internally-threaded nut for a coaxial connector, and may be identical to the internally-threaded nut 110 discussed above that is provided on the coaxial connector 100 of FIGS. 2A-2D. Accordingly, further description of the nut 210 will be omitted here. An O-ring, gasket or other member 216 (see FIGS. 3C and 3D) may be positioned between the internally-threaded nut 210 and the connector body 220 to reduce or prevent water or moisture ingress into the interior of the connector 200. The internally-threaded nut 210 may rotate freely around the contact post 240 and the connector body 220.

The connector body 220 may comprise a generally cylindrical body piece having an open interior. The outer and/or inner diameter of the connector body 220 may vary along the length of the connector body 220, with the forward portion of the connector body 220 having smaller inner and outer diameters than a rear portion of the connector body 220. The connector body 220 may be formed, for example, of brass or steel or another metal or metal alloy. The connector body 220 includes an external groove 222 that may be configured to receive a first connector engaging member of a compression tool. The rear end of the connector body 220 includes an internal annular ridge that acts as a stop 224.

The inner contact post 240 is mounted within both the connector body 220 and the internally-threaded nut 210. The inner contact post 240 has a generally annular shape and includes a base portion 242 that is positioned inside the internally-threaded nut 210 and a distal end that is adjacent the read end 204 of the connector 200. The inner contact post 240 is used to connect the internally-threaded nut 210 to the connector body 220. The outside surface of the inner contact post 240 may include one or more serrations, teeth, lips or other structures 246 that are provided at or near the distal end thereof. The inner contact post 240 may comprise, for example, a brass or steel post. A prepared coaxial cable 10 (not shown) is inserted into and over the external surfaces of the inner contact post 240 in the same manner that it is inserted over the inner contact post 140 of connector 100, and hence the description thereof will be omitted.

The compression sleeve 250 may comprise an annular tube that has a front end 252 that is positioned within the connector body 220. The compression sleeve 250 may be formed of either a rigid or a resilient material (e.g., a metal, a metal alloy, plastic, etc.). A circumferential groove 254 may be provided in the external surface of the compression sleeve 250 near the front end 252 thereof An O-ring 256 may be disposed in this circumferential groove 254 to reduce or prevent water migration into the interior of the connector 200. The interior surface of the compression sleeve 250 may also include a first stop 258 that prevents the compression sleeve 250 from travelling rearwardly any farther than the annular stop 224 that is provided on the interior surface of the rear end of the connector body 220. The interior surface of the compression sleeve 250 further includes a reduced diameter area 260 and a sloped transition region 262. As will be discussed herein, this reduced diameter area 260 and transition region 262 are used to lock a coaxial cable (not shown) within the connector 200. Finally, the compression sleeve 250 further includes a thickened region 264 at the rear end thereof that includes a forward sidewall 266. A second connector engaging member of a compression tool (not shown) may be used to engage the compression sleeve 250 just forward of the sidewall 266 and then activation of the compression tool may cause the second connector engaging member of the compression tool to move rearwardly such that it imparts a force on sidewall 266 that forces the compression sleeve 250 to move rearwardly with respect to the connector body 220.

FIG. 3C illustrates the compression sleeve 250 in its unseated position, which is the position that the compression sleeve 250 may be in when shipped from the factory and/or prior to the insertion of a coaxial cable therein. FIG. 3D illustrates the compression sleeve 250 in its seated position, which is the position in which the compression sleeve 250 is moved when the coaxial connector is mounted on the end of a coaxial cable to form a coaxial jumper cable. The exterior surface of the compression sleeve 250 and the interior surface of the connector body 220 may further include cooperating structures (not shown) that are designed to allow the compression sleeve to be moved from the unseated position of FIG. 3C to the seated position o FIG. 3D, but which are further designed to prevent the compression sleeve from moving back to the unseated position once it has been moved to the seated position.

A coaxial cable such as coaxial cable 10 of FIGS. 1A-1B may be terminated into the F-style coaxial connector 200 of FIGS. 3A-3D as follows. First, the end portion of the coaxial cable 10 may be prepared in the manner discussed above. Next, with the compression sleeve 250 in its unseated position (i.e., in the position illustrated in FIG. 3C), the prepared end of the coaxial cable 10 is inserted into the rear of the connector 200. The inner core 18 of the coaxial cable 10 (i.e., inner conductor 12, dielectric 14 and tape 16) is axially inserted into the cylindrical chamber 230 defined by the inside diameter of the contact post 240, while the electrical shielding wires 20 and tape 22 and the cable jacket 24 are inserted within the annular chamber 232 defined by the exterior of the contact post 240 and the inside diameter of the compression sleeve 250 so as to circumferentially surround the outer surface of inner contact post 240. The prepared end of the coaxial cable 10 is inserted as far as it will go into the connector 200 so that the central conductor 12 thereof extends all the way through the inner contact post 240 into the threaded portion of the internally-threaded nut 210. When the coaxial cable 10 is fully inserted within the connector 200, the folded back electrical shielding wires 20 and any tape 22 will extend as far forwardly as they can possibly go so that they make physical and electrical contact with a sidewall 226 of the connector body 220. The longitudinal length of the annular chamber 232 that receives the electrical shielding wires 20 and any tape 22 may be greater than the longitudinal length of the folded back portion of the electrical shielding wires 20 and any tape 22 so that an unprepared segment of the coaxial cable 10 enters into a portion of the annular chamber 232,

Next, the installer may take a compression tool (not shown) and place a first gripping element thereof in the circumferential groove 222 in the exterior surface of the connector body 220 and place a second gripping element of the compression tool adjacent the thickened section 264 of the compression sleeve 250. The installer then activates the compression tool (e.g., by squeezing together the handles of a pliers-like compression tool), which forces the compression sleeve 250 and the Connector body 220 to move away from each other in the longitudinal direction (i.e., the compression sleeve 250 moves rearwardly in the axial direction). As the compression sleeve 250 moves rearwardly, the sloped transition area 262 moves adjacent to the serration 246 on the exterior of the contact post 240, thereby reducing the width of the radial gap that exists between the serration 246 and the interior surface of the compression sleeve 250. As the compression sleeve 250 is moved farther rearwardly, eventually the reduced diameter area 260 moves adjacent to the serration 246, thereby reducing the width of the radial gap even farther. The rearward movement of the compression sleeve 250 stops when the stop 258 on the compression sleeve 250 engages the stop 224 on the rear end of the connector body 220. At this point, the compression sleeve 250 is in its seated position of FIG. 3D.

As can be seen by comparing FIGS. 3C and 3D, when the compression sleeve 250 is forced into its seated position, the radial gap is reduced from a gap having a distance G3 in FIG. 3C to a gap having a distance G4 in FIG. 3D. The gap G4 may be designed to be less than the thickness of the electrical shielding wires 20, tape 22 and cable jacket 24 of coaxial cable 10. Consequently, as the radial gap is reduced from the distance G3 to the distance G4 as the compression sleeve 250 is moved to its seated position, the connector body 220 and the serration 246 on the inner contact post 240 impart a generally 360-degree circumferential compressive force on the electrical shielding wires 20, tape 22 and cable jacket 24, thereby locking the shielding wires/tape 20, 22 and the cable jacket 24 therebetween.

One potential challenge with coaxial connectors is that individuals may, at times, pull or tug on the coaxial cable that is terminated into the coaxial connector. As such, coaxial connectors must be designed to sufficiently resist this pulling force so that the coaxial cable cannot readily be pulled out of the connector. As noted above, the coaxial connectors according to embodiments of the present invention have compression elements that move rearwardly to lock a coaxial cable within the connector. As such, the compression element moves in the same direction as a pulling force on the coaxial cable, whereas with a conventional coaxial connector, the compression element is moved to its seated position by pushing the compression element in a direction that is exactly opposite any pulling force on the coaxial cable that is terminated therein. As such, with conventional coaxial connectors, any pulling force on a coaxial cable imparts a force on the compression element that attempts to pull the compression element from the seated to the unseated position. As such, stops must be provided that are sufficient to resist such a force. With the coaxial connectors according to embodiments of the present invention, the pulling force merely serves to hold the compression element in the seated position, and hence the stops for preventing the compression element from returning to the unseated position may not need to resist as high of a force.

It should also be noted that the compressive forces that are imparted onto a coaxial cable that is locked into a coaxial connector according to embodiments of the present invention may be designed to have a significant transverse component as opposed to a rearward component, as such transverse forces may be more effective at locking the coaxial cable within the connector. Moreover, as noted above, the contact posts of the coaxial connectors according to embodiments of the present invention may include one or more serrations, teeth or the like that will further assist in resisting any pulling forces on the coaxial cable.

While exemplary embodiments of the present invention have been described above with respect to two different F-style coaxial connector designs, it will be appreciated that the rearwardly seating compression elements according to embodiments of the present invention may be implemented in a wide variety of different coaxial connector designs, specifically including BNC connectors, MCX connectors, MMCX connectors, RCA connectors, APC-7 connectors and the like as well as the F-style connectors discussed above. Thus, it will be appreciated that the present invention and the claims appended hereto are not limited to F-style coaxial connectors.

As discussed above, for some embodiments of the present invention, a pliers-like compression tool may be used that has a first gripping element that is inserted within an external groove in the connector body and a second gripping element that is inserted within an external groove in the compression sleeve. In some embodiments, the tool may be designed to have a switch that reverses the direction in which the gripping elements of the tool move. Such a tool may be designed to work with both conventional coaxial connectors and the coaxial connectors according to embodiments of the present invention.

It will be appreciated that the connector bodies described herein may be any housing or body piece that receives an end of a coaxial cable that is to be attached to the connector. As noted above, the connector body may comprise a single-piece or a multi-piece connector body. It will likewise be appreciated that the compression sleeves described herein may be implemented as any sleeve that is configured to be received within or over top of a connector body in order to directly or indirectly impart a generally circumferential compressive force on an end of a coaxial cable that is received within the connector body when the compression sleeve is moved to a seated position within the connector body. The inner contact posts described herein may be any post or other structure within the connector that receives the coaxial cable either within and/or on the post.

While the present invention has been described above with reference to exemplary embodiments that are depicted in the accompanying drawings, the present invention may be embodied in many different forms. Accordingly, it will be appreciated that the present invention should not be construed as limited to the embodiments set forth herein; rather, these embodiments are provided so that this disclosure will be thorough and complete, and will fully convey the scope of the invention to those skilled in the art.

In the drawings, the size of lines and elements may be exaggerated for clarity. It will also be understood that when an element is referred to as being “coupled” to another element, it can be coupled directly to the other element, or intervening elements may also be present. In contrast, when an element is referred to as being “directly coupled” to another element, there are no intervening elements present. Likewise, it will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present.

Unless otherwise defined, all technical and scientific terms used herein have the same meaning as commonly understood by one of ordinary skill in the art to which this invention belongs. The terminology used in the description of the invention herein is for the purpose of describing particular embodiments only and is not intended to be limiting of the invention. As used in the description of the invention and the appended claims, the singular forms “a”, “an” and “the” are intended to include the plural forms as well, unless the context clearly indicates otherwise. As used herein, the term “and/or” includes any and all combinations of one or more of the associated listed items.

In the drawings and specification, there have been disclosed typical embodiments of the invention and, although specific terms are employed, they are used in a generic and descriptive sense only and not for purposes of limitation, the scope of the invention being set forth in the following claims.

1. A coaxial connector having a rear cable-receiving end and a front connection end that is opposite the cable-receiving end, comprising:
a connector body having a front end that extends toward the front connection end of the coaxial connector and a rear end opposite the front end; and
a compression element that is configured to move between an unseated position and a seated position,
wherein the compression element is configured to impart a compressive force to secure one or more elements of a cable within the connector body when the compression element is in the seated position, and
wherein the compression element is closer to the front connection end of the coaxial connector when in the unseated position than when in the seated position.

2. The coaxial connector of claim 1, wherein the coaxial connector comprises an F-style coaxial connector that further includes:
a rotatable nut that is mounted on the front end of the connector body; and
an inner contact post that is at least partly within the connector body.

3. The coaxial connector of claim 2, wherein the compression element is permanently attached to the connector body.

4. The coaxial connector of claim 2, wherein the compression element is positioned between the connector body and the inner contact post.

5. The coaxial connector of claim 2, wherein the compression element is positioned over an outer surface of the connector body.

6. The coaxial connector of claim 2, wherein the rear end of the connector body includes an opening, and wherein the contact post extends rearwardly through the opening beyond the rear end of the connector body.

7. The coaxial connector of claim 2, wherein the compression element has a front end and a rear end, and wherein the contact post extends rearwardly beyond the rear end of the compression element when the compression element is in the unseated position.

8. The coaxial connector of claim 2, wherein the compression element has a front end and a rear end, and wherein both the front end and the rear end of the compression element are between the front end and the rear end of the connector body when the compression element is in the unseated position.

9. The coaxial connector of claim 1, wherein the connector body comprises a two-piece connector body that include a first metal body element that forms the front end of the connector body and a second resilient body element that forms the rear end of the connector body.

10. The coaxial connector of claim 9, wherein the second resilient body element is partially positioned inside the first metal body element.

11. The coaxial connector of claim 9, wherein the second resilient body element includes a generally cylindrical element that has an open interior, and wherein a rear end of the cylindrical element flares outwardly.

12. The coaxial connector of claim 11, wherein the rear end of the cylindrical element includes a plurality of slots.

13-15. (canceled)

16. The coaxial connector of claim 3, wherein the contact post extends farther rearwardly than does the connector body.

17. A coaxial jumper cable having a coaxial cable that has first end and the coaxial connector of claim 1 terminated onto the first end of the coaxial cable.

18. A coaxial connector having a front connection end and a rear cable-receiving end that is opposite the front connection end, comprising:
a connector body having a front end that extends toward a front connection end of the coaxial connector and a rear end opposite the front end;
a rotatable nut that is mounted on the front end of the connector body;
an inner contact post that is positioned within a rear portion of the rotatable nut and within the connector body; and
a compression element that is permanently attached to the connector body that is configured to move rearwardly from an unseated position to a seated position.

19. The coaxial connector of claim 18, wherein a rear end of the compression element is closer to the front connection end of the coaxial connector than is a rear end of the contact post when the compression element is in the unseated position.

20. The coaxial connector of claim 18, wherein a rear end of the compression element is closer to the front connection end of the coaxial connector than is a rear end of the connector body when the compression element is in the unseated position.

21. The coaxial connector of claim 18, wherein the compression element does not obscure the view into the rear end of the coaxial connector when the compression element is in the unseated position.

22. A method of terminating a coaxial connector onto an end of a coaxial cable, the method comprising:
inserting the end of the coaxial cable into a rear cable-receiving end of the coaxial connector; and
moving a compression element of the coaxial connector along a longitudinal axis of the coaxial connector in a direction from a front connection end of the coaxial connector toward the rear cable-receiving end of the coaxial connector in order to impart a compressive force on at least a portion of the coaxial cable that locks the coaxial cable within the coaxial connector.

23. (canceled)

24. The method of claim 22, wherein the connector body comprises a two-piece connector body that includes a first metal body element that forms the front end of the connector body and a second resilient body element that forms the rear end of the connector body, and wherein the compression element imparts an inward force on the second resilient body element that forces the second resilient body element to move inwardly towards the longitudinal axis of the coaxial connector when the compression element is moved rearwardly from an unseated position to a seated position.
